(19) United States
(12) Patent Application Publication
(10) Pub. No.: US 2008/0138889 A1
(43) Pub. Date: Jun. 12, 2008

(54) Semiconductor Device

(75) Inventors: Yumiko Noda, Kanagawa (JP); Yasuko Watanabe, Kanagawa (JP); Yasuyuki Arai, Kanagawa (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 11/795,862

(22) PCT Filed: Feb. 3, 2006
(86) PCT No.: PCT/JP06/02305

§ 371 Date: Jul. 24, 2007

(30) Foreign Application Priority Data
Feb. 10, 2005 (JP) 2005-035291

(51) Int. Cl. C12M 1/34; B01J 19/00

(52) U.S. Cl. 435/287.2; 422/68.1

(57) ABSTRACT

A semiconductor device with improved convenience is provided by having an antenna for converting an electromagnetic wave into an electric signal, a detecting portion for detecting chemical reaction, and a control portion for controlling the antenna and the detecting portion. The detecting portion includes at least a detecting element, and the control portion includes at least a transistor. The detecting element includes a reactive layer for solidifying at least any one of a nucleic acid, a protein, an enzyme, an antigen, an antibody and a microbe. Alternatively, a semiconductor device includes an antenna, a detecting portion, a control portion, and a memory portion. The memory portion includes at least a memory element, and the memory element includes a first conductive layer, a second conductive layer, and a layer between the first conductive layer and the second conductive layer.

### TECHNICAL FIELD

The present invention relates to a semiconductor device which can transmit and/or receive data without contact.

### BACKGROUND ART

In recent years, development of a semiconductor device which can transmit and/or receive data without contact is advanced, and in some market, introduction of the semiconductor device is initiated. Such a semiconductor device is called as RFID (Radio Frequency Identification), an ID tag, an ID chip, an IC tag, an IC chip, an RF tag (Radio Frequency), an RF chip, a wireless tag, a wireless chip, an electronic tag, and an electronic chip.

A semiconductor device includes a plurality of elements including a transistor or the like, and an antenna, and data can be transmitted and received to/from an external device (a reader/writer) through electromagnetic wave. Recently, it has been attempted to monitor or control products by providing a semiconductor device for various products. For example, by attaching a semiconductor device to a product, a management system which can easily perform not only stock management such as controlling the number of stocks or status of stocks, but also automatic product management is proposed (refer to the Patent Document 1).

In addition, a semiconductor device is proposed to be used for a security device and a security system for increasing an effect of crime prevention (refer to Patent Document 2).

In addition, a method for preventing unauthorized uses such as exploitation is proposed by mounting an IC chip on paper money, securities or the like (refer to Patent Document 3). In this manner, it is proposed that a semiconductor device be used in various fields.

[Patent Document 1] Japanese Patent Laid-Open No. 2004-359363

[Patent Document 2] Japanese Patent Laid-Open No. 2003-303379

[Patent Document 3] Japanese Patent Laid-Open No. 2001-260580

### DISCLOSURE OF INVENTION

It is an object of the present invention to provide a semiconductor device which is increased its convenience by using an advantage that data transmission and reception are possible without contact.

A semiconductor device of the present invention includes an arithmetic processing circuit which conducts arithmetic processing, a detecting portion which detects chemical reaction, and an antenna. The arithmetic processing circuit has a plurality of transistors, the detecting portion has a plurality of detecting elements, and the antenna has a conductive layer.

Each of the plurality of detecting elements has a reactive layer for solidifying at least any one of a nucleic acid, a protein, an enzyme, an antigen, an antibody and a microbe. Specifically, the detecting element has a first layer and a second layer. The first layer is a conductive layer, and the second layer is a reactive layer. Alternatively, the detecting element has a first layer, a second layer and a third layer. The first layer and the third layer are conductive layers, and the second layer is a reactive layer.

The present invention can provide a semiconductor device with improved convenience, which is capable of detecting chemical reaction by a detecting element, and transmitting the data to an external device through an antenna.

In addition, the semiconductor device of the present invention has a memory portion for storing data, in addition to the above component elements. The memory portion has a plurality of memory elements, and each of the memory elements have a layer containing an organic compound. Specifically, each of the plurality of memory elements includes the first layer, the second layer and the third layer. The first layer and the third layer are conductive layers, while the second layer is a layer containing an organic compound.

As described above, since the structure of the invention is simple, a manufacturing process is not complicated, and thus, reduction of a manufacturing cost can be realized. In addition, with such a simple structure, an area occupied by one memory element can be reduced. Thus, a large capacity of the memory portion can be realized. Further, there are such advantages that the memory portion is nonvolatile and data can be written thereto many times.

In addition, the arithmetic processing circuit, the detecting portion and the antenna included in the semiconductor device of the present invention are provided over the same substrate. In addition, the arithmetic, the detecting portion, the antenna and the memory portion included in the semiconductor device of the present invention are provided over the same substrate. Accordingly, it is not necessary to mount components, and a semiconductor device which realizes a reduction of size, thickness, weight and cost can be provided.

A substrate over which a circuit or the like is provided in a semiconductor device of the present invention is a glass substrate. In comparison with a single crystalline substrate, a glass substrate is cheaper and can have a long side. Thus, a mass production is possible, and a semiconductor device with reduced cost can be provided.

A semiconductor device of the present invention includes an antenna which converts an electromagnetic wave into an electrical signal, a detecting portion which detects chemical reaction, and a control portion which controls the antenna and the detecting portion. The detecting portion includes at least a detecting element, and the control portion includes at least a transistor. In addition, a semiconductor device of the present invention includes an antenna, a detecting portion, a control portion, and a memory portion which stores data. The control portion controls the antenna, the detecting portion, and the memory portion. The memory portion includes at least a memory element, and the memory element has a first conductive layer, a second conductive layer, and a layer between the first conductive layer and the second conductive layer. The layer between the first conductive layer and the second conductive layer contains at least one of an organic compound and an inorganic compound.

In the semiconductor device, the control portion includes an arithmetic processing circuit, a power supply circuit, a demodulation circuit, a modulation circuit, a control circuit which controls the detecting element, a control circuit which controls the memory element and the like. The power supply circuit generates a power source electrical potential by using an AC (alternating-current) electronic signal supplied from the antenna, and outputs the generated power source electrical potential to other circuits. The demodulation circuit demodulates an AC electronic signal supplied from the antenna. The modulation circuit modulates a signal generated in the antenna. The control circuit that controls the detecting element (also called a first control circuit and a detecting control circuit) corresponds to a circuit that controls signal reading of the detecting element. Further, the control circuit which controls the memory element (also called a second control circuit and a memory control circuit) corresponds to a column driver and a row driver included in the memory portion.

The present invention makes it possible to detect chemical reaction of an object, since the present invention includes the detecting portion. Further, detection results of the detecting portion can be transmitted to an external device, for example a reader/writer, through the antenna, since the present invention includes the antenna. As a result, a semiconductor device with improved convenience can be provided.

Since the present invention has a memory portion having a simple structure, a manufacturing process is not complicated. Thus, cost reduction is realized. Further, an area occupied by one memory portion can be miniaturized, and thus a large capacity of a memory portion can be realized. Moreover, there are such advantages that the memory portion is nonvolatile and data can be written thereto many times.

### BRIEF DESCRIPTION OF DRAWINGS

In the accompanying drawings:

FIG. 1 shows a semiconductor device of the present invention;

FIGS. 2A and 2B show a semiconductor device of the present invention;

FIG. 3 shows a semiconductor device of the present invention;

FIG. 4 shows a semiconductor device of the present invention;

FIG. 5 shows a semiconductor device of the present invention;

FIG. 6 illustrates the system which uses a semiconductor device of the present invention;

FIG. 7 shows a semiconductor device of the present invention; and

FIG. 8 shows a semiconductor device of the present invention.

### BEST MODE FOR CARRYING OUT THE INVENTION

The embodiment modes of the present invention will be described hereinafter referring to the accompanying drawings. Note that the present invention is not limited to the description below, and it is easily understood by those skilled in the art that the embodiment modes and details herein disclosed can be modified in various ways without departing from the purpose and the scope of the invention. Therefore, the present invention should not be interpreted as being limited to the description of the embodiment modes to be given below. In a structure of the present invention described below, reference numerals indicating the same portion may be used in different drawings in common.

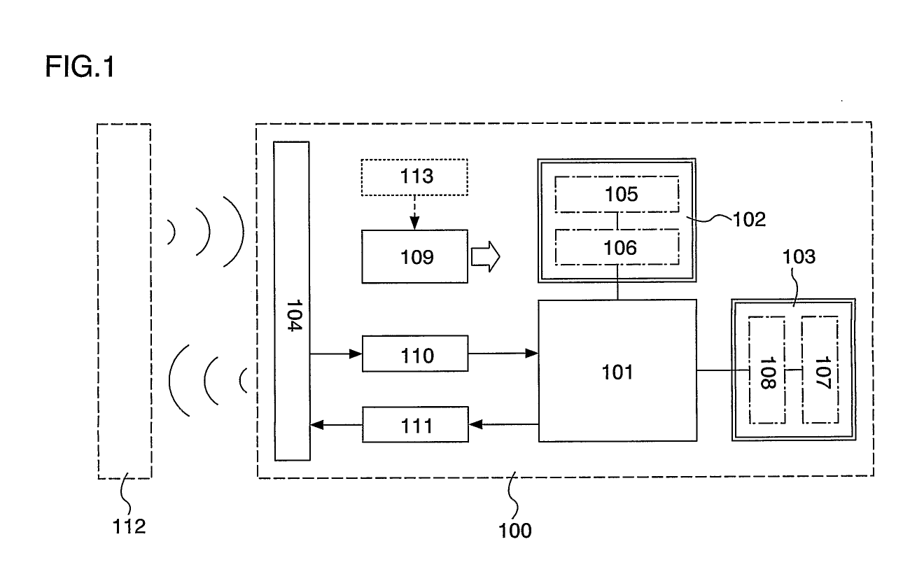

A structure of a semiconductor device of the present invention is described referring to FIG. 1. A semiconductor device 100 includes an arithmetic processing circuit 101, a detecting portion 102, a memory portion 103, an antenna 104, a power supply circuit 109, a demodulation circuit 110, and a modulation circuit 111. In addition, the semiconductor device 100 has a battery 113 depending on its use. The detecting portion 102 has a detecting element 105 and a detecting control circuit 106. The memory portion 103 has a memory element 107 and a memory control circuit 108. The semiconductor device 100 transmits and receives data to/from an external device through the antenna 104. The external device means, for example, a reader/writer 112.

The arithmetic processing circuit 101 operates based on a signal inputted from the reader/writer 112. The operation of the arithmetic processing circuit 101 corresponds, for example, to amplification of data detected by the detecting portion 102, conversion of data, data writing to the memory portion 103, data reading from the memory portion 103, outputting the necessary data to the reader/writer 112 and the like.

The detecting portion 102 includes a function to detect a gas component or a liquid component of an object by chemical function. The detecting portion 102 includes the detecting element 105 for detecting chemical reaction of an object and the detecting control circuit 106 for controlling operation of the detecting element 105.

The detecting element 105 has a high sensitivity only to an objective component among coexisting components since it is aimed to detect chemical reaction of the objective component in an object. Moreover, the detecting portion 105 has a reactive layer having high selectivity, which is not affected by the coexisting components. The reactive layer is formed by solidifying a nucleic acid, a protein, an enzyme, an antigen, an antibody or a microbe.

A structure of the reactive layer included in the detecting element 105 varies depending on its object. Specifically, when existence of the complementary alignment is detected by hybridization, the detecting element 105 includes a reactive layer for solidifying a nucleic acid. Detecting the complementary arrangement leads to unravel human genes, as well as facilitating the research and development of genes related to disease. Further, it makes it possible to realize tailor-made medical treatment by which medical products and treatment are selected depending on the individual physical condition.

In the case of detecting an interactive protein, the detecting element 105 includes a reactive layer for solidifying a protein.

In the case of detecting a component in which enzyme acts in a specific manner, the detecting element 105 includes a reactive layer for solidifying an enzyme. In this case, enzymatic reaction realizing molecular recognition in a biologic body is used. The enzyme is, for example, glucose oxidase, alcohol oxidase, pyruvate oxidase, uricase, urease or the like.

In the case of utilizing a specific property of reaction of an antigen antibody, the detecting element 105 includes a reactive layer for solidifying an antigen or an antibody. In this case, reaction of an antigen antibody in immunity is used.

In the case of detecting a component in which an enzyme included in a microbe acts in a specific manner, the detecting element 105 includes a reactive layer for solidifying a microbe. The microbe is, for example, nitrifier, uncharacterized bacteria or the like.

The detecting portion 102 has at least one, preferably a plurality of detecting elements 105. When the detecting portion 102 has a plurality of the detecting elements 105, it is preferable to change composition of a reactive layer included in each of the plurality of detecting elements 105. By changing composition of a reactive layer included in each of the plurality of detecting elements, it is possible to detect interaction or specific action massively and concurrently. Therefore, chemical reaction of an object can be detected with a high throughput.

The interaction or specific action generated in a reactive layer is outputted as an electrical signal. In other words, data detected by the detecting element 105 is outputted as an electrical signal to the outside. More specifically, the electrical signal detected by the detecting element 105 is outputted to the detecting control circuit 106 or the arithmetic processing circuit 101, and then is amplified and converted in the detecting control circuit 106 or the arithmetic processing circuit 101 to be outputted to the outside.

The memory portion 103 has a function to store data, and it includes the memory element 107 and the memory control circuit 108 which controls data writing into the memory element 107 and data reading from the memory element 107. The memory portion 103 stores data such as an identification number of the semiconductor device, and a detection result of the detecting portion 102. The identification number of the semiconductor device is used to be distinguished from other semiconductor devices when the detection result of the detecting portion 102 is transmitted to the outside.

For the memory portion 103, one or more of an organic memory, DRAM (Dynamic Random Access Memory), SRAM (Static Random Access Memory), FeRAM (Ferroelectric Random Access Memory), mask ROM (Read Only Memory), PROM (Programmable Read Only Memory), EPROM (Electrically Programmable Read Only Memory), EEPROM (Electrically Erasable and Programmable Read Only Memory), and a flush memory is/are used. The organic memory includes a stack in which a layer containing an organic compound is interposed between a pair of conductive layers. Since such a stack has a simple structure, a manufacturing process can be simplified. Thus, the cost can be reduced. Further, an area of the stack can be easily miniaturized due to its simple structure, and thus, a large capacity can be realized. Moreover, there are such advantages that the memory portion is nonvolatile and data can be written thereto many times.

Next, an operation related to data transmission and reception between the semiconductor device 100 and the reader/writer 112 is described. At first, a signal transmitted to the semiconductor device 100 as an electromagnetic wave from the reader/writer 112 is converted to an AC electronic signal in the antenna 104. The power supply circuit 109 generates power supply voltage by using an AC electronic signal, and supplies power supply voltage to each circuit. The demodulation circuit 110 demodulates an AC electronic signal, and supplies it to the arithmetic processing circuit 101. The arithmetic processing circuit 101 conducts various arithmetic processing in accordance with the inputted signal, and outputs a signal to the detecting portion 102, the memory portion 103 and the like. The data detected by the detecting portion 102 is transmitted from the arithmetic processing circuit 101 to the modulation circuit 111, and a signal generated in the antenna 104 is modulated by the modulation circuit 111 in accordance with the data. The reader/writer 112 can read the data by receiving the modulated signal of the antenna 104 as an electromagnetic wave.

In the above structure, supply of power supply voltage to each circuit is conducted by using electromagnetic wave; however, it may be conducted by using the battery 113. In addition, by using the battery 113, power supply voltage may be supplied to each circuit with both an electromagnetic wave and the battery 113. In the case where a battery is not provided to the semiconductor device 100, it is unnecessary to exchange batteries. Thus, reduction in cost, thickness, weight and size can be realized.

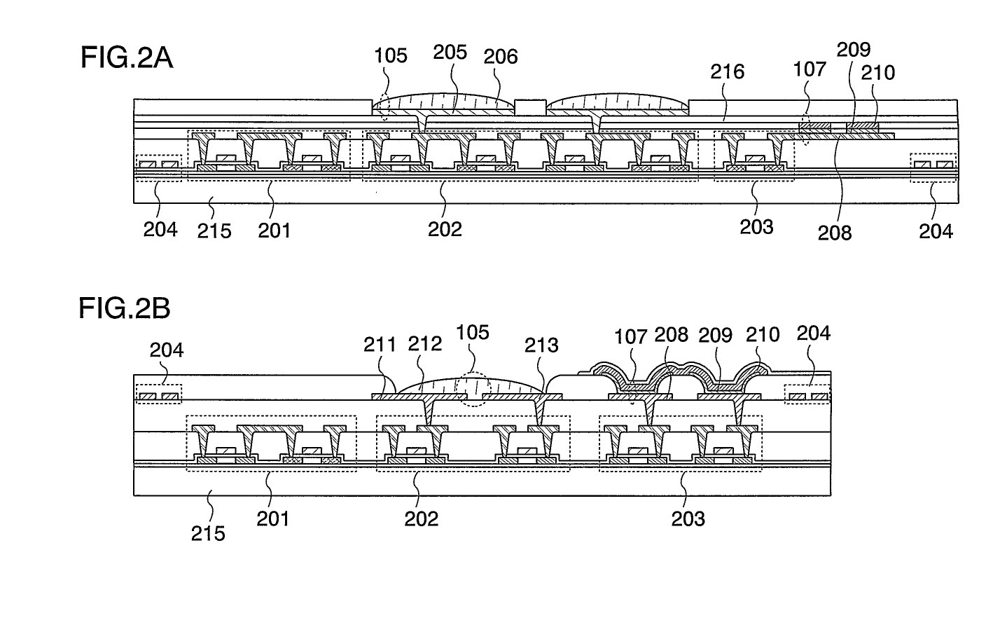

Next, description is made referring to FIG. 2A on a cross sectional structure of the semiconductor device 100 of the present invention including the arithmetic processing circuit 101, the detecting portion 102, the memory portion 103 and the antenna 104. The detecting portion 102 includes the detecting element 105 and the detecting control circuit 106, and the memory portion 103 includes the memory element 107 and the memory control circuit 108.

A semiconductor device of the present invention includes an element 201 which constitutes the arithmetic processing circuit 101, the detecting element 105, an element 202 which constitutes the detecting control circuit 106, the memory element 107, an element 203 which constitutes the memory control circuit 108 and a conductive layer 204 functioning as the antenna 104.

The detecting element 105 includes a conductive layer 205, and a reactive layer 206 for solidifying at least any one of a nucleic acid, a protein, an enzyme, an antigen, an antibody and a microbe. If chemical reaction is generated in the reactive layer 206, a voltage level of the conductive layer 205 changes. By reading such a change of the voltage level, chemical reaction of an object can be detected. A droplet discharge method such as an inkjet method is preferably used for forming the reactive layer 206.

It is to be noted that if chemical reaction is generated in the detecting element 105, light emission may be accompanied. In such a case, a light-receiving element such as a photodiode is preferably provided. By detecting the light emission of the detecting element 105 with the light-receiving element, chemical reaction can be detected.

The elements 201 to 203 include a transistor, a capacitor and a resistor element and the like. In the illustrated structure, a plurality of transistors is shown as the elements 201 to 203. The transistor may be either of a thin film transistor (TFT) or a field effect transistor (FET) which is obtained by providing a channel layer in a semiconductor substrate.

The memory element 107 corresponds to a stack of a conductive layer 208, a layer 209 containing an organic compound and a conductive layer 210. This structure shows the memory portion 103 of a passive matrix type where one memory element 107 is provided in one memory cell.

The conductive layers 208 and 210 included in the memory element 107 each correspond to a single-layer or stacked-layer structure formed of one or more elements selected from gold (Au), silver (Ag), platinum (Pt), nickel (Ni), tungsten (W), chrome (Cr), molybdenum (Mo), iron (Fe), cobalt (Co), copper (Cu), palladium (Pd), carbon (C), aluminum (Al), manganese (Mn), titanium (Ti), tantalum (Ta) or the like, or an alloy containing such element. As the metal alloy, there is a metal alloy containing Al and Ti. In addition, it is possible to use light-transmissive conductive oxide materials such as indium tin oxide (ITO), zinc oxide (ZnO), indium zinc oxide (IZO), zinc oxide doped with gallium (GZO) or the like.

In addition, the layer 209 containing an organic compound included in the memory element 107 corresponds to a single-layer or a stacked-layer structure of low molecular weight compounds such as 4,4′-bis[N-(1-naphthyl)-N-phenyl-amino]-biphenyl (abbreviation: α-NPD), and 4,4′-bis[N-(3-methylphenyl)-N-phenyl-amino]-biphenyl (abbreviation: TPD), or a single-layer or a stacked-layer structure of high molecular weight compounds such as poly(p-phenylenevinylene) (abbreviation: PPV), [methoxy-5-(2-ethyl)hexyloxane]-p-phenylenevinylene (abbreviation: MEH-PPV), poly(9,9-dialkylfluorene) (abbreviation: PAF), poly(9-vinylcarbazole) (abbreviation: PVK), polypyrrole, polythiophene, polyacetylene, polypyrene, and polycarbazole. In addition to the layers formed of low molecular weight compounds or high molecular weight compounds, a layer formed by mixing an inorganic compound with the low molecular weight compound or the high molecular weight compound can be provided in stacked layers.

The conductive layer 204 functioning as an antenna is provided in the same layer as a gate electrode of a transistor. However, the conductive layer 204 may be provided in the same layer as a pair of the conductive layers which constitutes a source wire and a drain wire of a transistor and the memory element 107, and a conductive layer which constitutes the detecting element 105. In this manner, by providing the conductive layer functioning as an antenna in the same layer as the conductive layer of other elements, a process to form a conductive layer functioning as an antenna is not required to be provided independently. Thus, a process to form a conductive layer functioning as an antenna and a process to form a conductive layer of other elements can be carried out concurrently. Therefore, a manufacturing process can be simplified, and reduction in manufacturing cost and improvement in yield can be realized.

In the case where the conductive layer functioning as an antenna is provided separately from the conductive layer of other elements, simplification of a manufacturing process and improvement in utilization efficiency of materials can be realized by using a printing method such as a screen printing, and a droplet discharge method. The structure shows a case where the conductive layer 204 functioning as an antenna is provided in the same layer as the conductive layer of other elements; however, it is possible to employ a structure in which a conductive layer functioning as an antenna is manufactured separately, and the conductive layer is attached in a later process.

When chemical reaction of an object is detected, the object is made contact with a reactive layer of the detecting element 105. It is to be noted that when the object is made contact with the reactive layer, the elements 201 to 203 or the like in a lower layer may be affected depending on the composition of an object. Therefore, for preventing such an effect, an insulating layer having excellent barrier properties is preferably formed as an insulating layer between the detecting element 105 and the elements 201 to 203 (for example an insulating layer 216) or as an insulating layer covering the elements 201 to 203. The insulating layer having the excellent barrier properties is, for example, an insulating layer including nitride, an insulating layer including oxide, an insulating layer including oxynitride, and an insulating layer including carbide. Specifically, it means an insulating layer formed with silicon oxide, silicon nitride, silicon oxynitride, diamond like carbon (DLC), nitride carbon or the like.

Next, description is made referring to FIG. 2B on a cross-sectional structure of a semiconductor device of the present invention which is different from the above structure. A semiconductor device of the present invention includes the detecting element 105, the memory element 107, the elements 201 to 203, and the conductive layer 204. This structure shows the memory portion 103 of an active matrix type where one switching transistor and the memory element 107 are provided in one memory cell.

The detecting element 105 includes a conductive layer 211, a reactive layer 212 for solidifying at least any one of a nucleic acid, a protein, an enzyme, an antigen, an antibody and a microbe, and a conductive layer 213. When chemical reaction is generated in the reactive layer 212, a resistance value between the conductive layer 211 and the conductive layer 213 changes. By reading the change of the resistance value with a voltage value or a current value, chemical reaction of an object is detected.

In the above structure, the arithmetic processing circuit 101, the detecting portion 102, the memory portion 103, and the antenna 104 are provided over a substrate 215. The substrate 215 corresponds to substrates such as a glass substrate, a quartz substrate, and a metal substrate, over which an insulating layer is formed, a stainless substrate, over which an insulating layer is formed, a substrate formed with an organic resin (for example, a plastic substrate), a film which is formed with polypropylene, polyester, vinyl, polyvinyl fluoride, vinyl chloride or the like, paper formed with a fibrous material, a base material film which is formed with polyester, polyamide, an inorganic evaporation film, paper or the like, and a stacked-layer film of an adhesive synthetic resin film (for example, an acrylic synthetic resin, an epoxy synthetic resin) or the like.

In the above structure (cf. FIG. 2A, FIG. 2B), the arithmetic processing circuit 101, the detecting portion 102, the memory portion 103 and the antenna 104 are provided over the substrate 215; however, the present invention is not limited to this structure. A plurality of elements which constitutes the arithmetic processing circuit 101 or the like may be peeled off the substrate 215. By peeling the plurality of elements off the substrate 215, reduction in size, thickness and weight can be realized.

As the substrate 215, a substrate having low heat resistance such as a substrate formed with an organic resin may be sometimes used. In such a case, after elements are formed over a glass substrate having high heat resistance, the elements may be peeled off the substrate and subsequently the peeled elements may be attached to a substrate having low heat resistance.

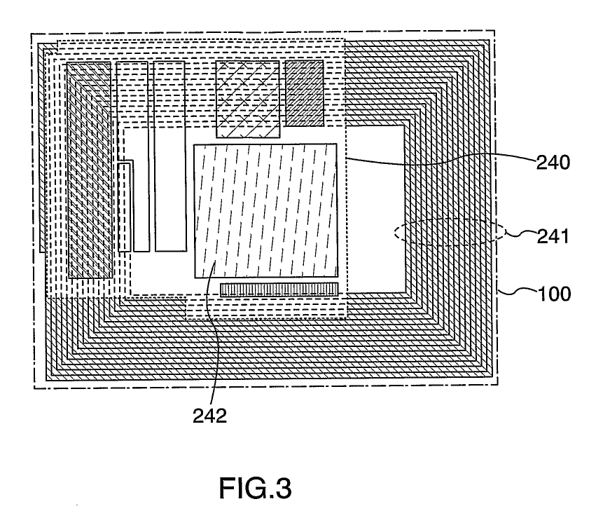

Next, description is made referring to FIG. 3 on a top view structure of a semiconductor device of the present invention. The semiconductor device 100 of the present invention includes a thin film integrated circuit 240 provided with a plurality of elements which constitutes a plurality of circuits such as the detecting portion 102, and a conductive layer 241 functioning as the antenna 104. The conductive layer 241 functioning as the antenna 104 is electrically connected to the thin film integrated circuit 240. The detecting portion 102 is in an exposed state, and when chemical reaction of an object is detected, the object is made contact with the reactive layer 242. For example, by dropping the object over the reactive layer by a droplet discharge method, the object is made contact with the reactive layer 242. Alternatively, by putting a semiconductor device in a solution including the object, the object is made contact with the reactive layer 242.

In the above structure, one example that the conductive layer 241 functioning as the antenna 104 is provided in coiled shape and electromagnetic induction method is applied is shown; however, a semiconductor device of the present invention is not limited to this. It is possible to apply micro-wave method. In the case of the micro-wave method, a shape of the conductive layer 241 functioning as the antenna 104 is determined properly by a wavelength of an electromagnetic wave.

### EMBODIMENT 1

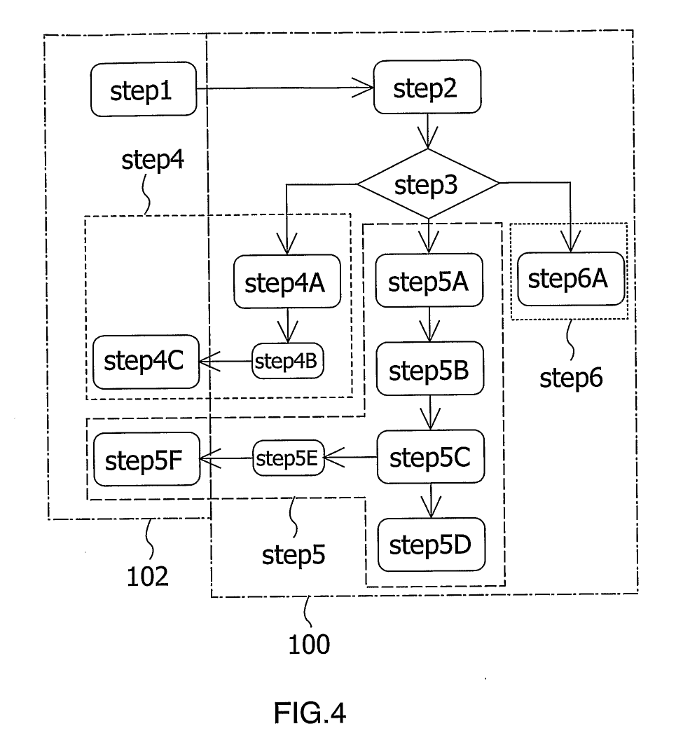

Description is made referring to FIG. 4 on the operation of data transmission and reception between the semiconductor device 100 of the present invention and the reader/writer 112.

The reader/writer 112 transmits control signals such as a signal for reading data, a signal for activating a detecting portion, and a signal for writing data, to the semiconductor device 100 (step 1). The semiconductor device 100 receives a control signal transmitted by the reader/writer (step 2), and the arithmetic processing circuit 101 distinguishes the control signal (step 3). Based on the control signal distinguished by the arithmetic processing circuit 101, which operation should be conducted is determined among three operations. The three operations correspond to: data reading operation from a memory portion 103 (step 4), a detecting operation of chemical reaction of an object with the detecting portion 102 (step 5), and a data writing operation to the memory portion 103 (step 6).

In the data reading operation from the memory portion 103 (step 4), the memory control circuit 108 is activated at first, and data stored in the memory element 107 is read (step 4A). Next, data read from the memory element 107 is transmitted to the reader/writer 112 (step 4B). The reader/writer 112 receives data supplied from the semiconductor device 100 (step 4C).

In the detecting operation of chemical reaction of an object by using the detecting portion 102, the detecting portion 102 is activated at first (step 5A). Next, chemical reaction of an object is detected by the detecting element 105 (step 5B), and the detecting element 105 outputs data of the detected chemical reaction to the detecting control circuit 106 as an electric signal. In the detecting control circuit 106 or the arithmetic processing circuit 101, conversion and amplification of an electrical signal are performed (step 5C). Subsequently, the data which has been converted and amplified is written into the memory portion 103 (step 5D). Alternatively, the data which has been converted and amplified is transmitted to the reader/writer 112 (step 5E). The reader/writer 112 receives data supplied from the semiconductor device 100 (step 5F).

In the data writing operation to the memory portion 103 (step 6), the memory control circuit 108 is activated at first, and data transmitted from the reader/writer 112 is written into the memory element 107 (step 6A).

### EMBODIMENT 2

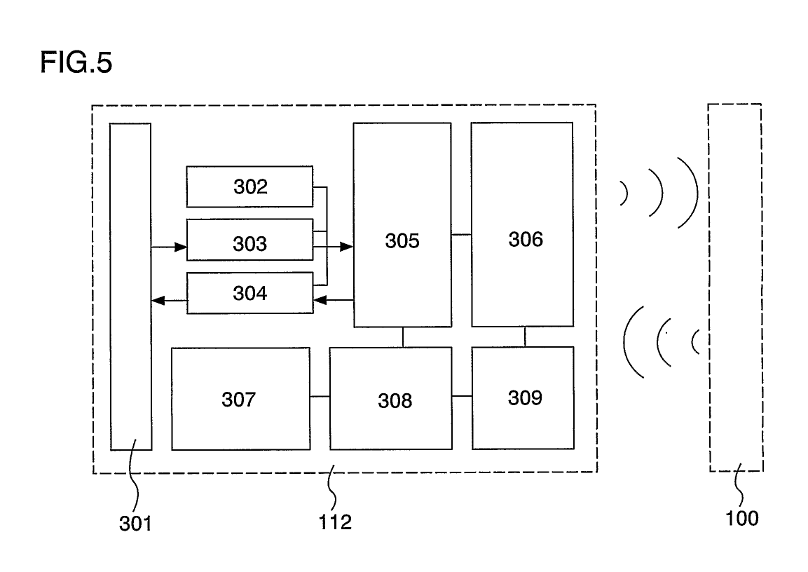

Description is made referring to FIG. 5 on a structure of a semiconductor device of the present invention and the reader/writer 112 which transmits and receives data. The reader/writer 112 includes an antenna 301, an oscillator 302, a demodulation circuit 303, a modulation circuit 304, an arithmetic processing circuit 305, an external interface circuit 306, a memory portion 307, an encryption/decryption circuit 308, and a power supply circuit 309. The encryption/decryption circuit 308 transmits and receives a control signal through encryption or decryption.

At first, description is made on the case where a signal is transmitted to the semiconductor device 100 from the reader/writer 112. The arithmetic processing circuit 305 outputs a control signal to the modulation circuit 304. In the modulation circuit 304, the supplied control signal is modulated into an AC electrical signal. Then, the modulated AC electrical signal is transmitted to the semiconductor device 100 through the antenna 301.

Next, description is made on the case where the reader/writer 112 receives a signal transmitted from the semiconductor device 100. The AC electrical signal received through the antenna 301 is demodulated by the demodulation circuit 303. Then, the demodulated electrical signal is outputted to the arithmetic processing circuit 305 and the external interface circuit 306. In data processing apparatus such as a computer connected to the external interface circuit 306, the data which is shown by an electrical signal is stored, and its data is shown by a display of the computer. In the memory portion 307 connected to the arithmetic processing circuit 305, the data is stored.

### EMBODIMENT 3

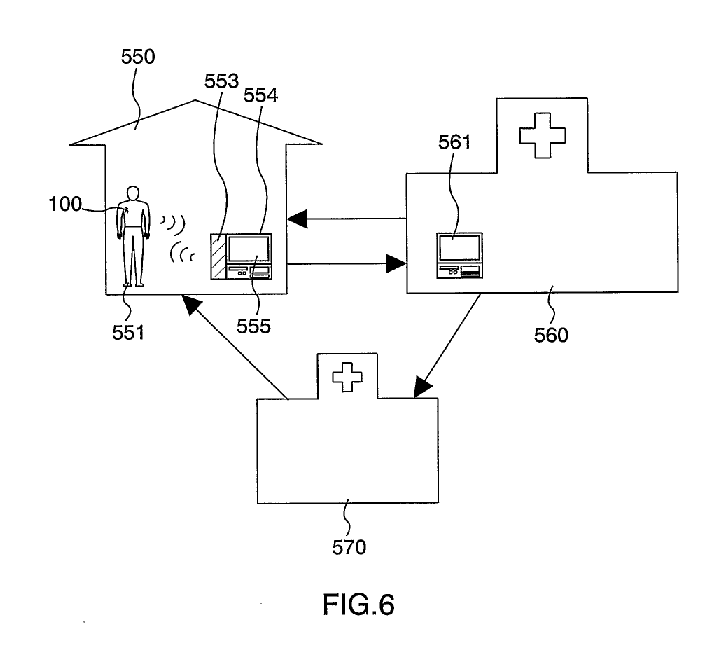

Description is made referring to FIG. 6 on a monitoring system of home medical care which is improved its convenience by using the semiconductor device of the present invention and network.

The semiconductor device 100 of the present invention may be brought by an individual 551, or kept at a location near the individual 551. The individual 551 corresponds to a plant or animals including human. In the case where the individual 551 brings the semiconductor device 100 with him/her, the semiconductor device 100 may be carried by the individual 551, attached to the individual 551, or embedded in the individual 551.

Chemical reaction of an object is detected by the semiconductor device 100, when it is necessary. The object here corresponds to sweat, tears, blood or the like, if the individual 551 is an animal. Data detected by the semiconductor device 100 is read by a reader/writer 553, and it is transmitted to a data processing apparatus 554 from the reader/writer 553. The data processing apparatus 554 displays the data transmitted from the reader/writer 553 in a display portion 555, and data processing is performed and analyzed as required. Then, its results are displayed on the display portion 555.

Moreover, the data processing apparatus 554 transmits the data, which is transmitted from the reader/writer 553, from home 550 to a medical institution 560 by using network. In the medical institution 560, the data transmitted from the home 550 is received by data processing apparatus 561, and a state of the individual 551 is monitored by controlling the received data. Further, a doctor diagnoses the individual 551 based on the data transmitted from home.

By detecting chemical reaction of an object regularly as the above, the individual 551 can be monitored by the medical institution 560 without going out. Further, when it is confirmed that the individual 551 has a problem, the medical institution 560 can respond to the situation rapidly. In addition, when the individual 551 is short of some nutrient, the data can be shown on the display portion 555 to warn the individual 551, and to display the nutrition to be taken on the display portion 555.

When the individual 551 goes out with the semiconductor device 100, chemical reaction of an object can be detected outside the house by mounting a reader/writer on information terminals such as a mobile phone. When it is confirmed that the individual 551 has a problem, the problem can be solved rapidly in the best way by exchanging data between the medical institution 560 which controls the data of the individual 551 and the medical institution 570 near the individual 551.

As the above, by using the semiconductor device 100 of the present invention and network, the physical state of the individual 551 is known not only by the individual 551, but also the medical institution 560. Thus, disease can be prevented beforehand, and the medical institution can respond to the situation rapidly in the best way, even if an unexpected disease and accident have occurred.

### EMBODIMENT 4

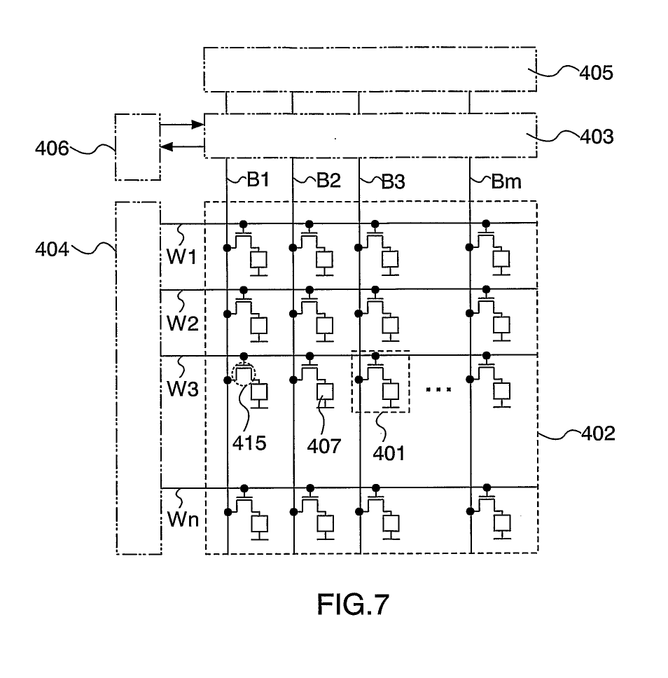

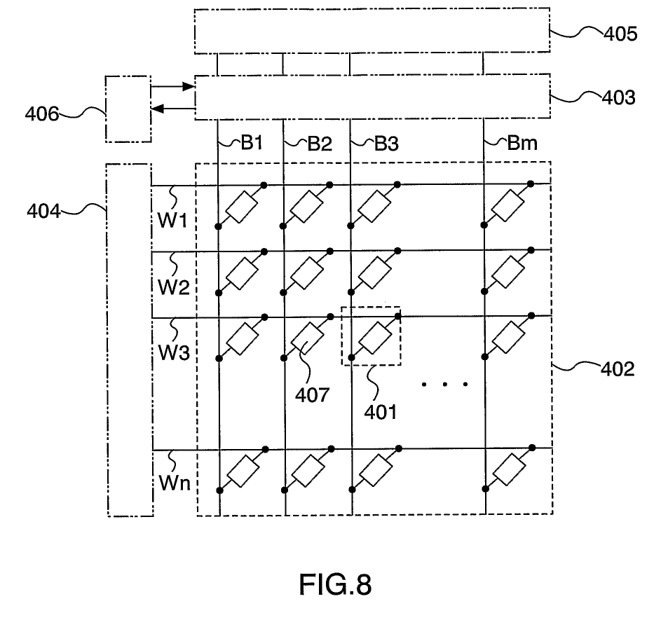

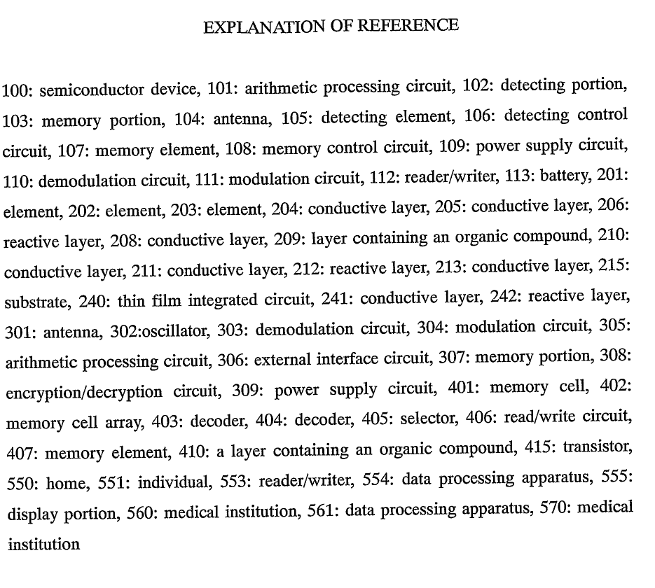

Description is made referring to FIGS. 7 and 8 on a structure of a memory portion included in a semiconductor device of the present invention.

The memory portion includes a plurality of bit lines B1 to Bm (m is natural number), a plurality of word lines W1 to Wn (n is natural number), and a memory cell array 402 including a plurality of memory cells 401. Further, a decoder 403 for controlling the plurality of bit lines B1 to Bm, a decoder 404 for controlling the plurality of word lines W1 to Wn, a selector 405, and a read/write circuit 406.

The memory cell array 402 may have a structure of an active matrix type or a passive matrix type. When the memory cell array 402 is an active matrix type, the memory cell 401 includes a transistor 415 and a memory element 407 (cf. FIG. 7). A gate of the transistor 415 is electrically connected to the bit line Ba (1≦a≦m), and either a source or drain of the transistor 415 is electrically connected to the word line Wb (1≦b≦n), while the other of the source or drain of the transistor 415 is electrically connected to one of a pair of electrodes of the memory element 407.

When the memory cell array 402 is a passive matrix type, the memory cell 401 includes the memory element 407 provided at an intersection of the bit line Ba, and the word line Wb (cf. FIG. 8).

Next, a data writing operation into a memory portion is described.

At first, description is made on the case where data is written into the memory portion by an electric action. At first, the memory cell 401 is selected by the decoder 403, the decoder 404, and the selector 405. Next, the read/write circuit 406 writes data into the selected memory cell 401. Specifically, when the read/write circuit 406 applies a predetermined voltage to a memory element in the selected memory cell 401, data is written. When the predetermined voltage is applied, a resistance value of the memory element changes. There are two cases for the change of the resistance value of the memory element: a case where the resistance value is increased, and a case where the resistance value is decreased. Both phenomena may be used for writing data. The phenomenon that the resistance value is increased uses a phenomenon that a layer containing an organic compound between a pair of electrodes is increased in resistance by applying a predetermined voltage to a memory element. The phenomenon that the resistance value is decreased uses a phenomenon that an interval between a pair of electrodes is shortened by applying a predetermined voltage to a memory element. In this manner, data is written into a memory portion by using a phenomenon that the resistance value of the memory element changes due to an electric action. For example, if a memory element in an initial stage is considered as data of 0, an electric action is applied to a memory element to which data of 1 is written.

Next, a case where data is written by an optical action is described. In this case, light is emitted to a layer containing an organic compound from the side of a light-transmissive conductive layer by an optical irradiation apparatus, for example a laser irradiation apparatus. Then, data is written into the irradiated memory element. The resistance value of the memory element changes due to light irradiation. There are two cases for the change of the resistance value of the memory element: a case where the resistance value is increased, and a case where the resistance value is decreased. Both phenomena may be used for writing data. In this manner, data is written into a memory portion by using a phenomenon that the resistance value of a memory element changes due to an optical action. For example, if a memory element in an initial stage is considered as data of 0, an optical action is applied to a memory element to which data of 1 is written.

Next, description is made on a data reading operation from a memory portion.

Data is read by an electric action, regardless of a method of writing data. Data is read by recognizing a difference of resistance values of memory elements with the decoders 403 and 404, a selector 405, and the read/write circuit.

An element having a rectifying property may be provided between one of the pair of conductive layers of the memory element and the layer containing an organic compound. The element having a rectifying property is, for example, a transistor having a gate and a drain connected to each other, a diode or the like. Accuracy of data reading can be improved since a direction of a current flow can be defined by providing the element having a rectifying property.

Next, description is made on a material used for a layer containing an organic compound included in a memory element.

In the case where data is written to a memory element by an electric action, the layer containing an organic compound is preferably formed with a low molecular weight material, a high molecular weight material, a singlet material, a triplet material or the like. Further, it is more preferable to form a layer containing an organic compound with a material containing both an organic compound and an inorganic compound than a material containing only an organic compound. For the layer containing an organic compound, a hole injecting layer, a hole transporting layer, a hole blocking layer, a light emitting layer, an electron transporting layer, an electron injecting layer and the like are employed, and the layer containing an organic compound either of a single layer or a multilayer. The layer containing an organic compound is preferably formed by a droplet discharge method represented by an inkjet method. Using a droplet discharge method can realize an improvement in utilization efficiency of materials as well as a reduction in manufacturing time and cost enable by the simplified manufacturing process.

In the case where data is written to a memory portion by an optical action, the layer containing an organic compound is preferably formed with a material which changes its property due to an optical action. For example, a conjugate polymer is preferably used, which is formed by adding a compound which generates acid by absorbing light (photo-acid generating agent). As the conjugated polymer, polyacetylene, polyphenylene vinylene, polythiophene, poly aniline, polyphenylene-ethylene or the like may be used. As the photo-acid generating agent, aryl sulfonium salt, aryl iodonium salt, an o-nitrobenzyltosylate, aryl sulfonic acid, p-nitrobenzyl ester, sulfonyl acetophenone, Fe-allene complex PF6 salt or the like may be employed.

1. A semiconductor device comprising:
an antenna for converting an electromagnetic wave into an electric signal;
a detecting portion for detecting chemical reaction; and
a control portion for controlling the antenna and the detecting portion;
wherein the detecting portion includes at least a detecting element;
wherein the control portion includes at least a transistor; and
wherein the detecting element includes a reactive layer for solidifying at least any one of a nucleic acid, a protein, an enzyme, an antigen, an antibody and a microbe.

2. A semiconductor device comprising:
an antenna for converting an electromagnetic wave into an electric signal;
a detecting portion for detecting chemical reaction;
a control portion for controlling the antenna and the detecting portion; and
a memory portion for storing data;
wherein the detecting portion includes at least a detecting element;
wherein the control portion includes at least a transistor;
wherein the memory portion includes at least a memory element;
wherein the detecting element includes a reactive layer for solidifying at least any one of a nucleic acid, a protein, an enzyme, an antigen, an antibody and a microbe; and
wherein the memory element includes a first conductive layer, a second conductive layer, and a layer between the first conductive layer and the second conductive layer.

3. The semiconductor device according to claim 1 or 2, wherein the detecting element includes a conductive layer being in contact with the reactive layer.

4. The semiconductor device according to claim 1 or 2, wherein the detecting element includes a first conductive layer, a second conductive layer, the reactive layer being in contact with the first conductive layer and the second conductive layer.

5. The semiconductor device according to claim 1, wherein the antenna, the detecting portion and the control portion are provided over a same substrate.

6. The semiconductor device according to claim 1, wherein the antenna, the detecting portion, and the control portion are provided over a same glass substrate.

7. The semiconductor device according to claim 2, wherein the antenna, the detecting portion, the control portion and the memory portion are provided over a same substrate.

8. The semiconductor device according to claim 2, wherein the antenna, the detecting portion, the control portion and the memory portion are provided over a same glass substrate.
